(19) United States
(12) Patent Application Publication
(10) Pub. No.: US 2024/0036255 A1
(43) Pub. Date: Feb. 1, 2024

(54) PUMP-SIGNAL COMBINER

(71) Applicant: Lumentum Operations LLC, San Jose, CA (US)

(72) Inventors: Ning LIU, Morgan Hill, CA (US); Jeff GREGG, San Jose, CA (US); Gongwen ZHU, San Jose, CA (US); Xiang PENG, San Ramon, CA (US); Guan SUN, San Jose, CA (US); Matthew KUTSURIS, Dublin, CA (US)

(21) Appl. No.: 17/936,114

(22) Filed: Sep. 28, 2022

Related U.S. Application Data
(60) Provisional application No. 63/369,448, filed on Jul. 26, 2022.

(51) Int. Cl. G02B 6/255; H01S 3/094; G02B 6/04

(52) U.S. Cl. CPC G02B 6/2552; H01S 3/094053; G02B 6/04

(57) ABSTRACT

A system may perform an uptapering process to cause a signal fiber to have a fiber core with a first uptapered thickness profile and a fiber cladding with a second uptapered thickness profile. The system may perform, after performing the uptapering process, an uptapering removal process to cause the fiber cladding of the signal fiber to not have the second uptapered thickness profile. The system may perform, after performing the uptapering removal process, a bundling process to bundle the signal fiber and a set of one or more pump fibers in a bundle configuration. The system may perform, after performing the bundling process, a bundle unification process to cause the bundle configuration to form a unified bundle configuration. The system may perform, after performing the bundle unification process, an attachment process to cause an end of the unified bundle configuration to attach to an end of an output fiber.

### CROSS-REFERENCE TO RELATED APPLICATION

This patent application claims priority to U.S. Patent Application No. 63/369,448, filed on Jul. 26, 2022, and entitled “PUMP-SIGNAL COMBINER.” The disclosure of the prior Application is considered part of and is incorporated by reference into this patent application.

### TECHNICAL FIELD

The present disclosure relates generally to a pump-signal combiner and to a pump-signal combiner formed by pre-processing a signal fiber to include an up-tapered fiber core.

### BACKGROUND

Pump-signal combiners are critical components of high-power fiber lasers. A pump-signal combiner combines pump light and signal light to increase a power of the signal light.

### SUMMARY

Some implementations described herein relate to a method of forming a pump-signal combiner. The method may include performing, by a system, an uptapering process to cause a signal fiber to have a fiber core with a first uptapered thickness profile and a fiber cladding with a second uptapered thickness profile. The method may include performing, by the system and after performing the uptapering process, an uptapering removal process to cause the fiber cladding of the signal fiber to not have the second uptapered thickness profile. The method may include performing, by the system and after performing the uptapering removal process, a bundling process to bundle the signal fiber and a set of one or more pump fibers in a bundle configuration. The method may include performing, by the system and after performing the bundling process, a bundle unification process to cause the bundle configuration to form a unified bundle configuration. The method may include performing, by the system and after performing the bundle unification process, an attachment process to cause an end of the unified bundle configuration to attach to an end of an output fiber.

Some implementations described herein relate to a method of forming a pump-signal combiner. The method may include performing, by a system, an uptapering process to cause a signal fiber to have a fiber core with a first uptapered thickness profile. The method may include performing, by the system and after performing the uptapering process, a bundling process to bundle the signal fiber and a set of one or more pump fibers in a bundle configuration. The method may include performing, by the system and after performing the bundling process, an attachment process to cause an end of the bundle configuration to attach to an end of an output fiber.

Some implementations described herein relate to a method of forming a pump-signal combiner. The method may include performing, by a system, an uptapering process to cause a signal fiber to have a fiber core with a first uptapered thickness profile. The method may include performing, by the system and after performing the uptapering process, a bundling process to bundle the signal fiber and a set of one or more pump fibers in a bundle configuration. The method may include performing, by the system and after performing the bundling process, a bundle unification process to cause the bundle configuration to form a unified bundle configuration.

### BRIEF DESCRIPTION OF THE DRAWINGS

FIGS. 1A-1B are diagrams of example implementations described herein.

FIGS. 2A-2E are diagrams of an example implementation of a process for forming a signal fiber described herein.

FIGS. 3A-3E are diagrams of an example implementation of another process for forming a signal fiber described herein.

FIGS. 4A-4C are diagrams of an example implementation of a process for forming a pump-signal combiner described herein.

FIGS. 5A-5C are diagrams of an example implementation of another process for forming a pump-signal combiner described herein.

FIGS. 6A-6B are diagrams of example implementations described herein.

FIGS. 7A-7B are diagrams of an example implementation of a process for forming a side coupler described herein.

FIG. 8 is a flowchart of an example process associated with forming a pump-signal combiner.

### DETAILED DESCRIPTION

The following detailed description of example implementations refers to the accompanying drawings. The same reference numbers in different drawings may identify the same or similar elements.

Pump combiners are critical components of high-power fiber lasers. A pump combiner combines pump light to create combined light with an increased power. In many cases, pump combiners are arranged in a bundle configuration, which is spliced to another optical structure (e.g., a master oscillator power amplifier (MOPA)/single pass fiber laser structure) that is configured to deliver many hundreds of watts (W)/kilowatts (kW) of pump power. A bundle configuration can be achieved by arranging pump fibers into a particular close-packed configuration (e.g., a hexagonal close-packing configuration, or the like), and fusing and tapering individual pump fibers into a bundle of a target size.

In some cases, a signal fiber is included, with the individual pump fibers, in the bundle. Consequently, performing a fusing and tapering process on the bundle (e.g., to fuse and taper the pump fibers), fuses the signal fiber to the pump fibers and also tapers the signal fiber. This often results in a signal fiber that is significantly reduced in size (e.g., from one end of the bundle to another end of the bundle), which can result in perturbance, or other distortion, of a signal beam that propagates through the signal fiber (e.g., end-to-end of the bundle). Further, the signal beam can leak out of the signal fiber core at a tapered area of the signal fiber (e.g., due to a decreased size of the signal fiber core).

Additionally, often the size of the signal fiber core inside the tapered bundle is mismatched with a size of an output fiber core (e.g., to which the signal fiber core is to be spliced). This increases an amount of the signal beam that leaks out of the signal fiber core. This reduces brightness and/or increases optical loss of the signal beam, which generates heat within the pump combiner. Accordingly, a performance (e.g., an optical performance and/or a thermal performance) of the pump combiner is impacted.

Some implementations described herein provide a pump-signal combiner (sometimes referred to herein as an N+1:1 pump-signal combiner). The pump-signal combiner may be formed by pre-processing a signal fiber to include an uptapered fiber core. This allows the fiber core of the signal fiber to be tapered down during a bundling process (e.g., without a size of the signal input fiber core being over-reduced as part of the bundling process).

In some implementations, pre-processing the signal fiber to make an uptapered fiber core may include heating and compressing a signal fiber to have a fiber core with an uptapered thickness profile or splicing the signal fiber to another signal fiber that has a fiber core with an uptapered thickness profile (e.g., that is made by downtapering a larger sized fiber core of the other signal fiber). Pre-processing the signal fiber may also include etching (e.g., using hydrofluoric (HF) acid), lasering, or machining the signal fiber to remove an uptapered thickness profile of a fiber cladding of the signal fiber (e.g., that formed as result of causing the fiber core of the signal fiber to have an uptapered thickness profile).

In some implementations, forming the pump-signal combiner includes: bundling the pre-processed signal fiber with pump fibers in a bundle configuration; tapering the fiber bundle (e.g., as part of a bundle unification process); and splicing the tapered fiber bundle to an output fiber. In this way, a size (e.g., a thickness) of the fiber core of the signal fiber is maintained (e.g., is the same as an original size of the fiber core) after tapering the fiber bundle. Further, the size of the fiber core of the signal fiber inside the bundle matches a size of a fiber core of the output fiber core. This minimizes and/or prevents laser light from leaking out of the fiber core of the signal fiber, and therefore a laser signal loss in the pump-signal combiner is minimized. This increases brightness and reduces generation of heat within the pump-signal combiner. Accordingly, a performance (e.g., an optical performance and/or a thermal performance) of the pump-signal combiner is improved in comparison to a pump combiner that does not include a pre-processed signal fiber described herein.

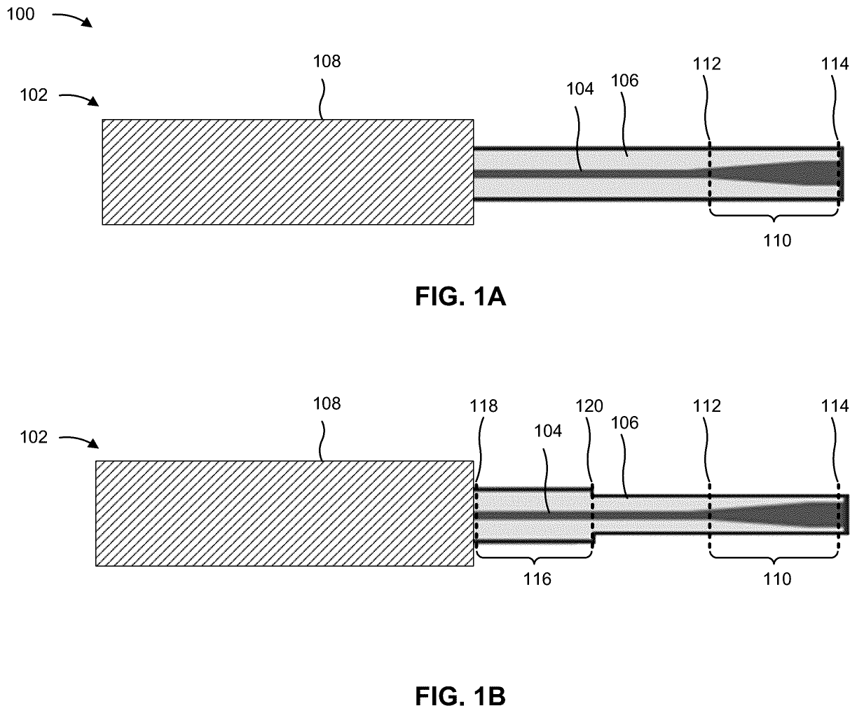

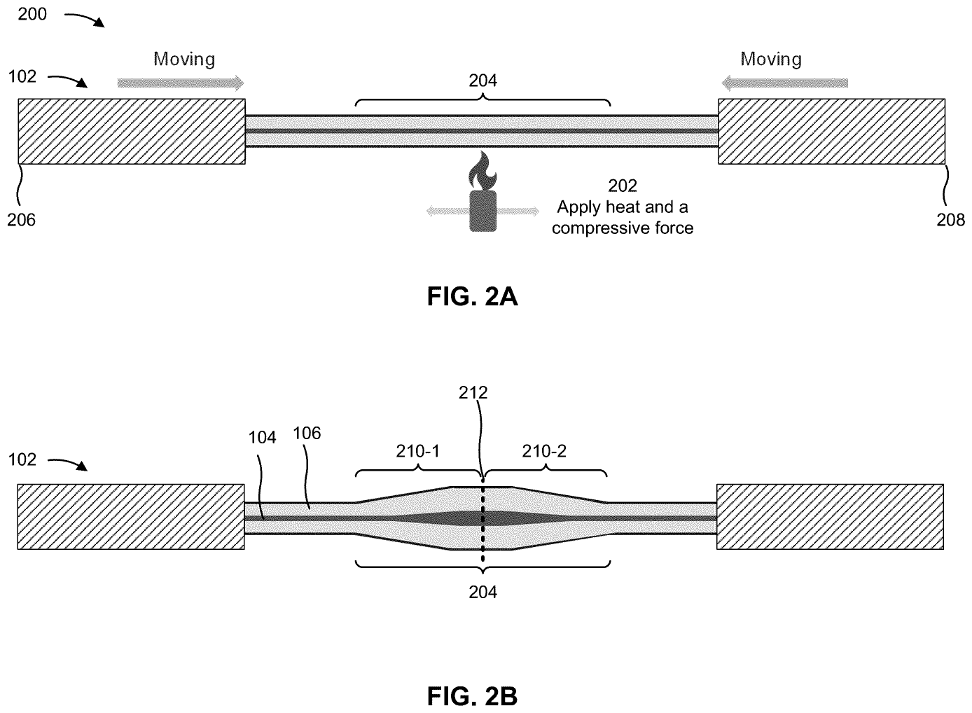

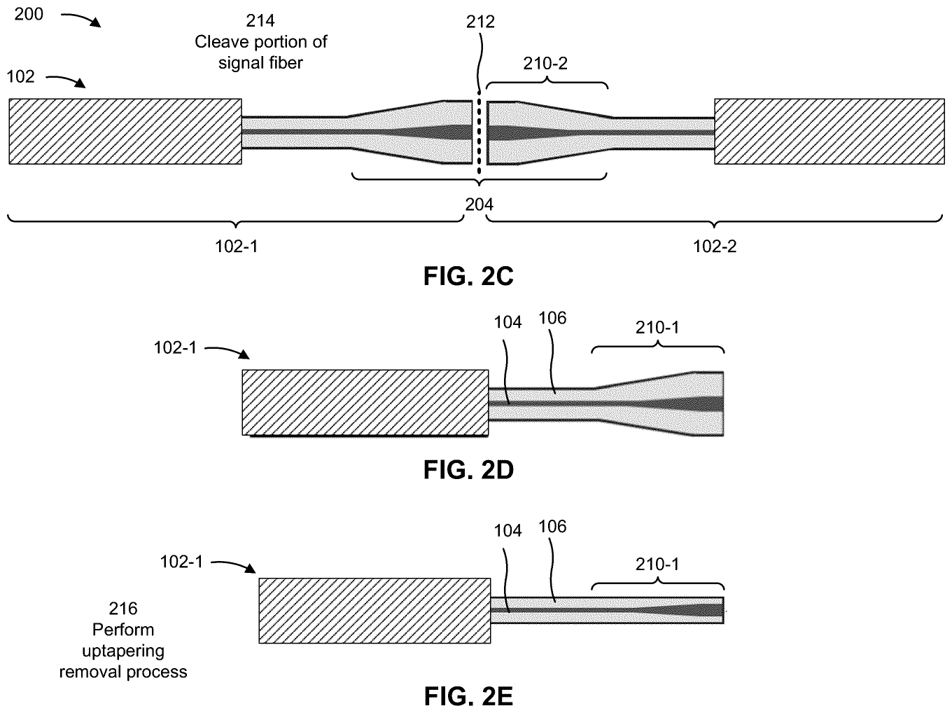

FIGS. 1A-1B are diagrams of example implementations 100 described herein. As shown in FIGS. 1A-1B, each example implementation 100 may include a signal fiber 102 (e.g., a longitudinal cross-section of the signal fiber 102), such as after an “uptapering process” and an “uptapering removal” process has been performed (e.g., as described herein in relation to FIGS. 2A-2E and/or 3A-3E). Accordingly, the signal fiber 102 may be termed a “pre-processed” signal fiber, or an “uptapered” signal fiber, among other terms.

The signal fiber 102 may include a fiber core 104, a fiber cladding 106, and/or a fiber coating 108. For example, the signal fiber 102 may include a fiber core 104 that is circumferentially surrounded by a fiber cladding 106, and may include a fiber coating 108, at at least one end (e.g., a left end, as shown in FIGS. 1A-1B) of the signal fiber 102, that circumferentially surrounds the fiber core 104 and the fiber cladding 106. In some implementations, the signal fiber 102 may comprise glass (e.g., a silica-based glass, a quartz-based glass, a fluorinated glass, or another type of glass). The signal fiber 102 may be configured to propagate (e.g., via the fiber core 104) a signal beam (e.g., from an input end of the signal fiber 102 to an output end of the signal fiber 102).

As shown in FIGS. 1A-1B, the fiber core 104 may have an uptapered thickness profile along a portion 110 of the signal fiber 102. That is, the fiber core 104 may be tapered along the portion 110 of the signal fiber 102 in association with a first ratio (e.g., a 1:2, a 1:3, a 1:3.75, or 1:5.2 taper ratio, among other examples), such that a thickness (e.g., a width, a diameter, or another thickness measurement) of the fiber core 104 at a first end 112 of the portion 110, is less than a thickness of the fiber core 104 at a second end 114 of the portion 110 (e.g., that is aligned with an end of the signal fiber 102).

As further shown in FIGS. 1A-1B, the fiber cladding 106 may have a first uniform (or nearly uniform) thickness profile along the portion 110 of the signal fiber 102. That is, a thickness (e.g., a width, a diameter, or another thickness measurement) of the fiber cladding 106 may not vary along the portion 110 of the signal fiber 102, from the first end 112 of the portion 110 to the second end 114 of the portion 110. For example, a difference between a maximum thickness and a minimum thickness of the fiber cladding 106 along the portion 110 of the signal fiber 102 may be less than or equal to a thickness difference threshold, which may be less than or equal to 10 μm, 15 μm, and/or 25 μm, among other examples.

As further shown in FIG. 1B, the fiber cladding 106 may have a second uniform thickness profile along a portion 116 of the signal fiber 102. For example, a thickness of the fiber cladding 106 may not vary along the portion 116 of the signal fiber 102, from a first end 118 of the portion 116 to a second end 120 of the portion 116 (e.g., that is closer to the first end 112 of the portion 110 of the signal fiber 102 than the second end 114 of the portion 110). In some implementations, the first uniform thickness profile may be thinner than the second uniform thickness profile. That is, a thickness of the fiber cladding 106 at any point along the portion 110 of the signal fiber 102 may be less than a thickness of the fiber cladding 106 at any point along the portion 116 of the signal fiber 102. In some implementations, as shown in FIG. 1A, the fiber cladding 106 may have a single uniform thickness profile along the signal fiber 102 (e.g., the thickness of the fiber cladding 106 may not vary, such as in a similar manner as that described above, along the portion 110, the portion 116, and any other portion of the signal fiber 102).

Additionally, or alternatively, the fiber core 104 may have a third uniform thickness profile along the portion 116 of the signal fiber 102. That is, a thickness (e.g., a width, a diameter, or another thickness measurement) of the fiber core 104 may not vary along the portion 116 of the signal fiber 102, from the first end 118 of the portion 116 to the second end 120 of the portion 116. For example, a difference between a maximum thickness and a minimum thickness of the fiber core 104 may be less than or equal to a thickness difference threshold, which may be less than or equal to 10 μm, 15 μm, and/or 25 μm, among other examples.

FIGS. 1A-1B are provided as an example. Other examples may differ from what is described with regard to FIGS. 1A-1B.

FIGS. 2A-2E are diagrams of an example implementation 200 of a process for forming a pre-processed signal fiber, or an uptapered signal fiber, such as the signal fiber 102 described herein. Accordingly, the process may be termed a “pre-processing” process or an “uptapering” process. As shown in FIGS. 2A-2E (e.g., that show a longitudinal cross-section of the signal fiber 102), the process may include one or more steps.

As shown in FIG. 2A, and by reference number 202, the process may include applying heat and a compressive force to a portion 204 of the signal fiber 102. For example, a system (e.g., that is configured to form a pre-processed signal fiber or an uptapered signal fiber), may hold the signal fiber 102 at a first end 206 (the left end of the signal fiber 102 shown in FIG. 2A) and/or a second end 208 (the right end of the signal fiber 102 shown in FIG. 2A), and may cause the first end 206 and the second end 208 to move toward each other (e.g., move inwardly, along a longitudinal axis of the signal fiber 102). This may cause a compressive force to be applied to the portion 204 of the signal fiber 102. At a same time (e.g., while the compressive force is applied to the portion 204 of the signal fiber 102), heat may be applied (e.g., using a scanning flame, or another heat source) to apply heat to the portion 204 of the signal fiber 102. As a result of the applied heat, the fiber core 104 and the fiber cladding 106 of the portion 204 of the signal fiber 102 may soften, and, as a result of the compressive force, respective thicknesses of the fiber core 104 and the fiber cladding 106 of the portion 204 of the signal fiber 102 may increase, such as shown in FIG. 2B.

As further shown in FIG. 2B, the portion 204 may comprise a first sub-portion 210-1 and a second sub-portion 210-2, wherein each sub-portion 210 may be a symmetrical version of the other sub-portion 210 about an axis 212 (e.g., a reflection of the other sub-portion 210 across the axis 212). The fiber core 104 may have a first uptapered thickness profile along the first sub-portion 210-1 of the portion 204 of the signal fiber 102 (e.g., in a similar manner as that described herein in relation to FIGS. 1A-1B), which may be associated with a first taper ratio. The fiber cladding 106 may have a second uptapered thickness profile along the first sub-portion 210-1 of the portion 204 of the signal fiber 102 (e.g., a thickness of the fiber cladding 106 at an end of the first sub-portion 210-1 farther from the axis 212, is less than a thickness of the fiber cladding 106 at an end of the first sub-portion 210-1 closer to the axis 212), which may be associated with a second taper ratio. The first taper ratio and the second taper ratio may be the same (e.g., equal to each other). Alternatively, the first taper ratio and the second taper ratio may be different (e.g., not equal to each other). Moreover, the fiber core 104 may have a complementary first uptapered thickness profile (e.g., that is a reflection of the first uptapered thickness profile) along the second sub-portion 210-2 of the portion 204 of the signal fiber 102, which may be associated with the first taper ratio. The fiber cladding 106 may have a complementary second uptapered thickness profile (e.g., that is a reflection of the second uptapered thickness profile) along the second sub-portion 210-2 of the portion 204 of the signal fiber 102, which may be associated with the second taper ratio.

As shown in FIG. 2C, and by reference number 214, the process may include cleaving the portion 204 of the signal fiber 102. For example, as shown in FIG. 2C, the process may include cleaving the portion 204 of the signal fiber 102 along the axis 212. In this way, the signal fiber 102 may be divided into two signal fibers 102, a first signal fiber 102-1 and a second signal fiber 102-1.

As shown in FIG. 2D, the first signal fiber 102-1 may include the sub-portion 210-1. Accordingly, the fiber core 104 of the first signal fiber 102-1 may have the first uptapered thickness profile along the first sub-portion 210-1 of the first signal fiber 102-1, which may be associated with the first taper ratio, and the fiber cladding 106 of the first signal fiber 102-1 may have the second uptapered thickness profile along the first sub-portion 210-1, which may be associated with the second taper ratio. In this way, the first sub-portion 210-1 of the first signal fiber 102-1 may be similar to the portion 110 of the signal fiber 102, as described herein in relation to FIGS. 1A-1B. Although not shown in FIG. 2D, the second signal fiber 102-2 may include the sub-portion 210-2. Accordingly, the fiber core 104 of the second signal fiber 102-2 may have the complementary first uptapered thickness profile along the second sub-portion 210-2 of the second signal fiber 102-2, which may be associated with the first taper ratio, and the fiber cladding 106 of the second signal fiber 102-2 may have the complementary second uptapered thickness profile along the second sub-portion 210-2, which may be associated with the second taper ratio. In this way, the second sub-portion 210-2 of the second signal fiber 102-2 may be similar to the portion 110 of the signal fiber 102, as described herein in relation to FIGS. 1A-1B.

As shown in FIG. 2E, and by reference number 216, the process may additionally include performing an uptapering removal process (e.g., that is part of the uptapering process, or, alternatively, is a separate process performed after completion of the uptapering process). The uptapering removal process may be performed to cause the fiber cladding 106 of the signal fiber 102-1 to not have the second uptapered thickness profile along the first sub-portion 210-1 of the signal fiber 102-1. For example, the uptapering removal process may be performed to cause the fiber cladding 106 of the signal fiber 102-1 to have a uniform thickness profile along the first sub-portion 210-1 of the signal fiber 102-1 (e.g., in a similar manner as that described herein in relation to FIGS. 1A-1B). In some implementations, the process may include performing at least one of an etching process (e.g., using HF acid), a lasering process (e.g., using a carbon dioxide (CO₂) laser), or a machining process (e.g., a grinding process) on the fiber cladding 106 of the signal fiber 102-1 (e.g., along the first sub-portion 210-1 of the signal fiber 102-1). In this way, the fiber cladding 106 may be caused to have a uniform thickness profile along the signal fiber 102-1 (e.g., similar to that shown in FIG. 1A), or more than one thickness profile along the signal fiber 102-1 (e.g., similar to that shown in FIG. 1B).

FIGS. 2A-2E are provided as an example. Other examples may differ from what is described with regard to FIGS. 2A-2E.

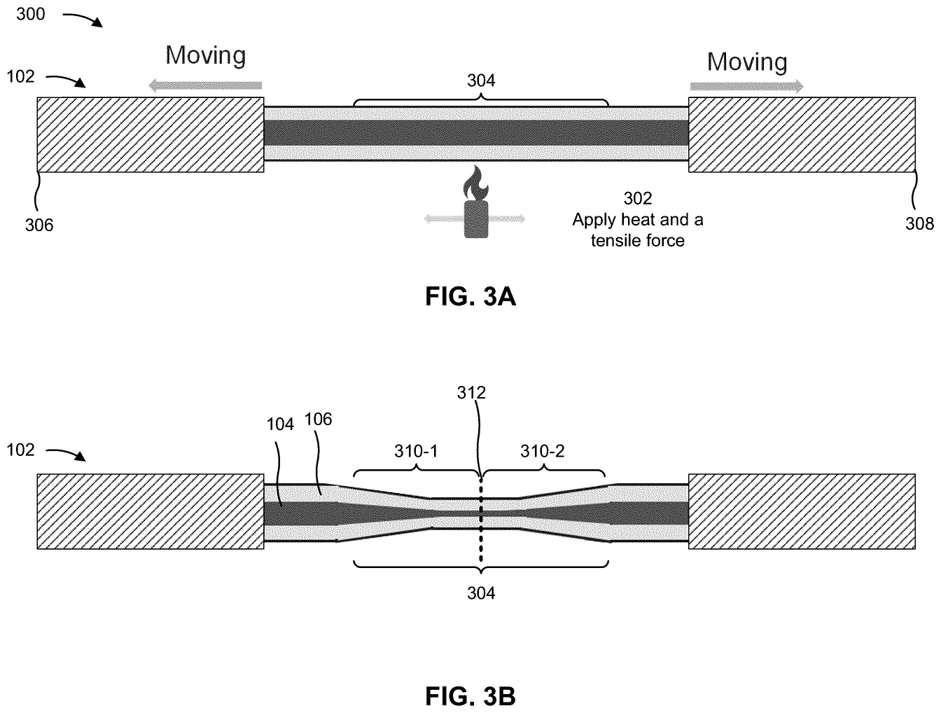

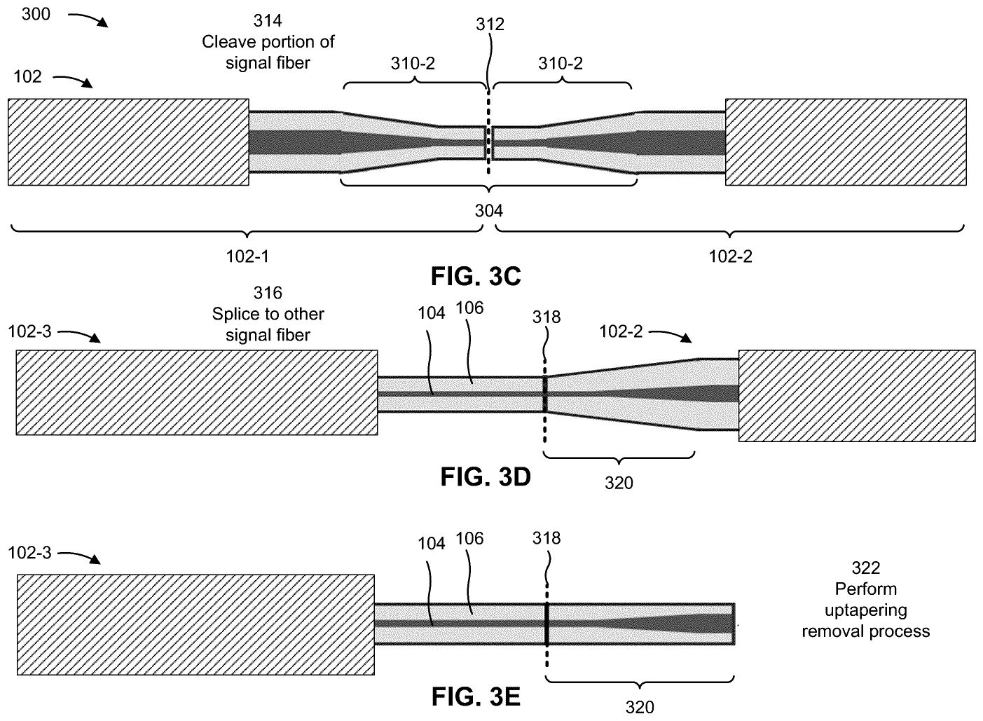

FIGS. 3A-3E are diagrams of an example implementation 200 of another process for forming a pre-processed signal fiber, or an uptapered signal fiber, such as the signal fiber 102 described herein. Accordingly, the process may be termed a pre-processing process or an uptapering process. As shown in FIGS. 3A-3E (e.g., that shows a longitudinal cross-section of the signal fiber 102), the process may include one or more steps.

As shown in FIG. 3A, and by reference number 302, the process may include applying heat and a tensile force to a portion 304 of the signal fiber 102. For example, a system (e.g., that is configured to form a pre-processed signal fiber or an uptapered signal fiber), may hold the signal fiber 102 at a first end 306 (the left end of the signal fiber 102 shown in FIG. 3A) and/or a second end 308 (the right end of the signal fiber 102 shown in FIG. 3A), and may cause the first end 306 and the second end 308 to move away from each other (e.g., move outwardly, along a longitudinal axis of the signal fiber 102). This may cause a tensile force to be applied to the portion 304 of the signal fiber 102. At a same time (e.g., while the tensile force is applied to the portion 304 of the signal fiber 102), heat may be applied (e.g., using a scanning flame, or another heat source) to apply heat to the portion 304 of the signal fiber 102. As a result of the applied heat, the fiber core 104 and the fiber cladding 106 of the portion 304 of the signal fiber 102 may soften, and, as a result of the tensile force, respective thicknesses of the fiber core 104 and the fiber cladding 106 of the portion 304 of the signal fiber 102 may decrease, such as shown in FIG. 3B.

As further shown in FIG. 3B, the portion 304 may comprise a first sub-portion 310-1 and a second sub-portion 310-2, wherein each sub-portion 310 may be a symmetrical version of the other sub-portion 310 about an axis 312 (e.g., a reflection of the other sub-portion 310 across the axis 312). The fiber core 104 may have a first downtapered thickness profile along the first sub-portion 310-1 of the portion 304 of the signal fiber (e.g., a thickness of the fiber core 104 at an end of the first sub-portion 310-1 that is farther from the axis 312 is greater than a thickness of the fiber core 104 at an end of the first sub-portion 310-1 that is closer to the axis 312), which may be associated with a first taper ratio. The fiber cladding 106 may have a second downtapered thickness profile along the first sub-portion 310-1 of the portion 304 of the signal fiber 102 (e.g., a thickness of the fiber cladding 106 at an end of the first sub-portion 310-1 that is farther from the axis 312, is greater than a thickness of the fiber cladding 106 at an end of the first sub-portion 310-1 that is closer to the axis 312), which may be associated with a second taper ratio. The first taper ratio and the second taper ratio may be the same (e.g., equal to each other). Alternatively, the first taper ratio and the second taper ratio may be different (e.g., not equal to each other). Moreover, the fiber core 104 may have a complementary first downtapered thickness profile (e.g., that is a reflection of the first downtapered thickness profile) along the second sub-portion 310-2 of the portion 304 of the signal fiber 102, which may be associated with the first taper ratio. The fiber cladding 106 may have a complementary second downtapered thickness profile (e.g., that is a reflection of the second downtapered thickness profile) along the second sub-portion 310-2 of the portion 304 of the signal fiber 102, which may be associated with the second taper ratio.

As shown in FIG. 3C, and by reference number 314, the process may include cleaving the portion 304 of the signal fiber 102. For example, as shown in FIG. 3C, the process may include cleaving the portion 304 of the signal fiber 102 along the axis 312. In this way, the signal fiber 102 may be divided into two signal fibers 102, a first signal fiber 102-1 and a second signal fiber 102-2.

As shown in FIG. 3D, and by reference number 316, the process may include splicing a signal fiber 102 (e.g., the first signal fiber 102-1 or the second signal fiber 102-1) to another signal fiber 102 (e.g., that has not undergone a pre-processing process or an uptapering process). For example, as shown in FIG. 3D, the process may include splicing the signal fiber 102-2 (e.g., formed as described herein in relation FIGS. 3A-3C) to a signal fiber 102-3 (e.g., that has not yet been subject to any uptapering process or downtapering process), such that that signal fiber 102-2 becomes part of the signal fiber 102-3. In some implementations, an end of the signal fiber 102-2 associated with the portion of the signal fiber 102-2 is spliced to an end of the signal fiber 102-3 (e.g., at a splice point 318), such that a thickness of the fiber core 104 of the signal fiber 102-2 at the end of the signal fiber 102-2 (e.g., at the splice point 318) matches (e.g., within a tolerance, which may be less than or equal to 1 μm, 3, μm, and/or 5 μm, among other examples) a thickness of a fiber core 104 of the signal fiber 102-3 at the end of the signal fiber 102-3 (e.g., at the splice point 318).

In this way, the signal fiber 102-3 may be formed (based on splicing to the signal fiber 102-2) to have a portion 320 that was previously the second sub-portion 210-2 of the signal fiber 102-2. Accordingly, the fiber core 104 of the signal fiber 102-3 may have a first uptapered thickness profile along the portion 320 of the signal fiber 102-3 (e.g., in a similar manner as that described herein in relation to FIGS. 1A-1B), which may be associated with a first taper ratio. The fiber cladding 106 of the signal fiber 102-3 may have a second uptapered thickness profile along the portion 320 of the signal fiber 102-3, which may be associated with a second taper ratio.

As shown in FIG. 3E, and by reference number 322, the process may additionally include performing an uptapering removal process (e.g., that is part of the uptapering process, or, alternatively, is a separate process performed after completion of the uptapering process). The uptapering removal process may be performed to cause the fiber cladding 106 of the signal fiber 102-3 to not have the second uptapered thickness profile along the portion 320 of the signal fiber 102-3. For example, the uptapering removal process may be performed to cause the fiber cladding 106 of the signal fiber 102-3 to have a uniform thickness profile along the portion 320 of the signal fiber 102-3 (e.g., in a similar manner as that described herein in relation to FIGS. 1A-1B). In some implementations, the process may include performing at least one of an etching process, a lasering process, or a machining process on the fiber cladding 106 of the signal fiber 102-3 (e.g., along the portion 320 of the signal fiber 102-3). In this way, the fiber cladding 106 may be caused to have a uniform thickness profile along the signal fiber 102-1 (e.g., similar to that shown in FIG. 1A), or more than one thickness profile along the signal fiber 102-1 (e.g., similar to that shown in FIG. 1B). In some implementations, the uptapering removal process may also include cleaving the signal fiber 102-3, such as to cause an end of the portion 320 of the signal fiber 102-3 to be aligned with an end of the signal fiber 102-3 (e.g., as shown in FIG. 3E).

FIGS. 3A-3E are provided as an example. Other examples may differ from what is described with regard to FIGS. 3A-3E.

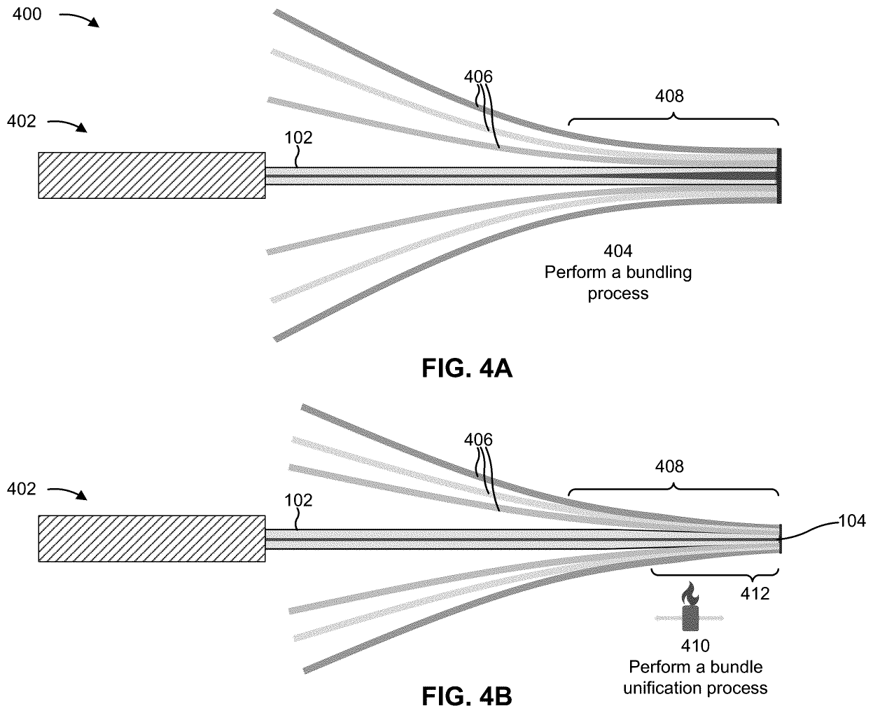

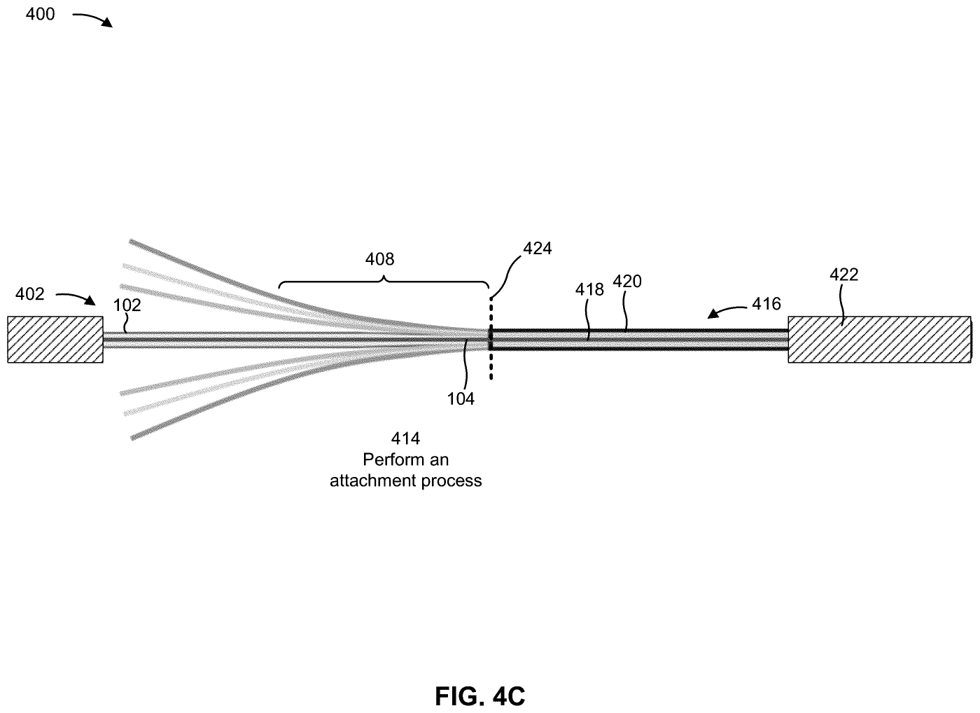

FIGS. 4A-4C are diagrams of an example implementation 400 of a process for forming a pump-signal combiner 402 described herein. As shown in FIGS. 4A-4C (e.g., that shows a longitudinal cross-section of the pump-signal combiner 402), the process may include one or more steps.

As shown in FIG. 4A, and by reference number 404, the process may include performing a bundling process to bundle a signal fiber 102 and a set of one or more pump fibers 406 in a bundle configuration 408. The signal fiber 102 may be a pre-processed signal fiber or an uptapered signal fiber, which may include the fiber cladding 106 with a single uniform thickness profile along the signal fiber 102 (e.g., as shown and described herein in relation to FIG. 1A), that may have been formed using a pre-processing or uptapering process (e.g., as described herein in relation to FIGS. 2A-2E and 3A-3E). Each pump fiber 406 may include a fiber core, a fiber cladding, and/or a fiber coating (not shown in FIGS. 4A-4C) that are respectively similar to the fiber core 104, the fiber cladding 106, and the fiber coating 108 of the signal fiber 102 described herein in relation to FIGS. 1A-1C. Each pump fiber 406 may be configured to propagate (e.g., via a fiber core of the pump fiber 406) a pump beam (e.g., from an input end of the pump fiber 406 to an output end of the pump fiber 406).

In some implementations, the bundling process may include a system (e.g., that is configured to form a pump-signal combiner) arranging the signal fiber 102 and the set of one or more pump fibers 406 in the bundle configuration 408, such that the signal fiber 102 and the set of one or more pump fibers 406 are packed closely together (e.g., such that a size of gaps between the signal fiber 102 and the set of one or more pump fibers 406 is minimized). For example, within a cross-section of the bundle configuration 408, the signal fiber 102 may be disposed in an inner area (e.g., of the cross-section of the bundle configuration 408) and the set of one or more pump fibers 406 may be disposed in association with a perimeter region (e.g., of the cross-section of the bundle configuration 408) such that the set of one or more pump fibers 406 touch and circumferentially surround the signal fiber 102.

As shown in FIG. 4B, and by reference number 410, the process may include performing a bundle unification process to cause the bundle configuration 408 to form a unified bundle configuration. For example, the bundle unification process may include applying heat and a tensile force to a portion 412 of the bundle configuration 408. For example, the system may hold the bundle configuration 408 at a first end of the portion 412 and/or a second end of the portion 412, and may cause the first end and the second end to move away from each other (e.g., move outwardly, along a longitudinal axis of the bundle configuration 408). This may cause a tensile force to be applied to the portion 412 of the bundle configuration 408. At a same time (e.g., while the tensile force is applied to the portion 412 of the bundle configuration 408), heat may be applied (e.g., using a scanning flame, or another heat source) to the portion 412 of the bundle configuration 408. As a result of the applied heat, the signal fiber 102 and the set of one or more pump fibers 406 may soften (e.g., along the portion 412 of the bundle configuration 408), and, as a result of the tensile force, the signal fiber 102 and the set of one or more pump fibers 406 may fuse together (e.g., partially fuse or completely fuse together along the portion 412 of the bundle configuration 408), such as shown in FIG. 3B. Further, the fiber core 104 of the signal fiber 102 may be caused to have a uniform thickness profile (e.g., along the portion 412 of the bundle configuration 408). That is, the signal fiber 102 may no longer be a pre-processed signal fiber or an uptapered signal fiber.

As shown in FIG. 4C, and by reference number 414, the process may include performing an attachment process to cause an end of the bundle configuration 408 (e.g., hereinafter referred to as the unified bundle configuration 408) to attach to an end of an output fiber 416 (e.g., that includes a fiber core 418, a fiber cladding 420, and/or a fiber coating 422). For example, the attachment process may include the system splicing the end of the unified bundle configuration 408 to the end of the output fiber 416 (e.g., at a splice point 424). This may cause an end of the fiber core 104 of the signal fiber 102 at the end of the unified bundle configuration 408 to attach to an end of the fiber core 418 of the output fiber 416. In some implementations, a thickness of the end of the fiber core 104 of the signal fiber 102 at the end of the unified bundle configuration 408 may match a thickness of the end of the fiber core 418 of the output fiber 416. For example, a difference between the thickness of the end of the fiber core 104 of the signal fiber 102 and the thickness of the end of the fiber core 418 of the output fiber 416 may be less than or equal to a thickness difference threshold, which may be less than or equal to 10 μm, 15 μm, and/or 25 μm, among other examples.

In this way, the system may form the pump-signal combiner 402 to include the signal fiber 102 and the set of one or more pump fibers 406 in the unified bundle configuration 408 that are attached to the output fiber 416. Accordingly, pump light propagated by the set of one or more pump fibers 406 may combine with a signal beam propagated by the signal fiber 102 within the unified bundle configuration 408. This may increase a power (e.g., an optical power) and/or a brightness of the signal beam. The signal beam (e.g., after combining with the pump light) may then propagate to the output fiber 416 and emit from the pump-signal combiner 402. Because the thickness of the end of the fiber core 104 of the signal fiber 102 at the end of the unified bundle configuration 408 may match the thickness of the end of the fiber core 418, the power and/or the brightness of the signal beam may be preserved (or power loss and/or brightness degradation may be minimized) as the signal beam propagates to the output fiber 416.

FIGS. 4A-4C are provided as an example. Other examples may differ from what is described with regard to FIGS. 4A-4C.

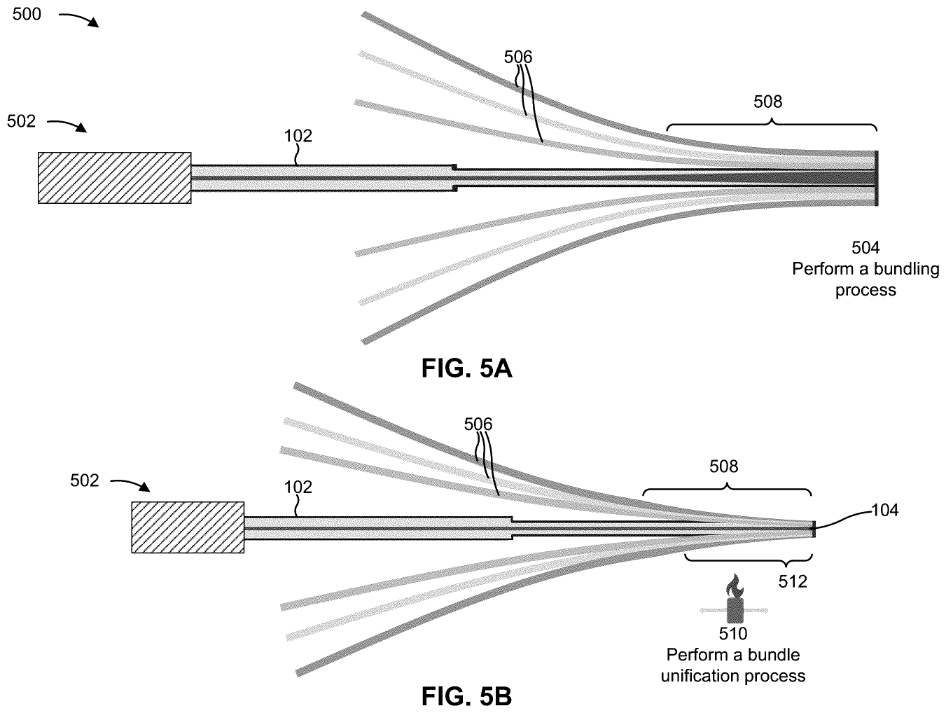

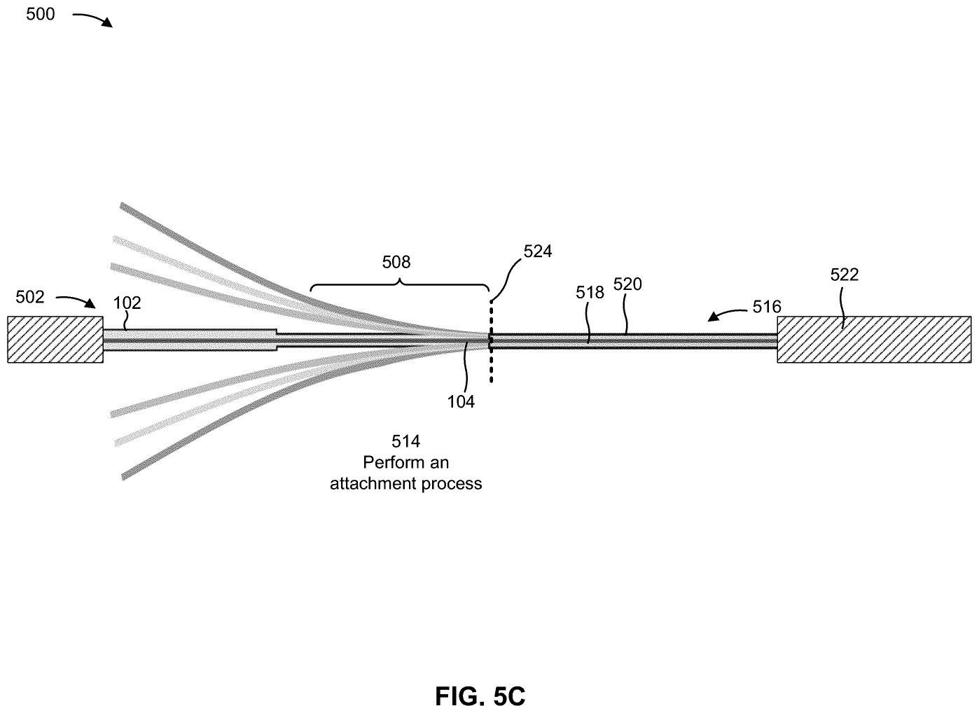

FIGS. 5A-5C are diagrams of an example implementation 500 of a process for forming a pump-signal combiner 502 described herein. As shown in FIGS. 5A-5C (e.g., that show a longitudinal cross-section of the pump-signal combiner 502), the process may include one or more steps.

As shown in FIG. 5A, and by reference number 504, the process may include performing a bundling process to bundle a signal fiber 102 and a set of one or more pump fibers 506 in a bundle configuration 508 (e.g., that are similar to the set of one or more pump fibers 406 and the bundle configuration 408, described herein in relation to FIGS. 4A-4C). The signal fiber 102 may be a pre-processed signal fiber or an uptapered signal fiber, which may include the fiber cladding 106 with more than one thickness profile along the signal fiber 102 (e.g., as shown and described herein in relation to FIG. 1B), that may have been formed using a pre-processing or uptapering process (e.g., as described herein in relation to FIGS. 2A-2E and 3A-3E).

In some implementations, the bundling process may include a system (e.g., that is configured to form a pump-signal combiner) arranging the signal fiber 102 and the set of one or more pump fibers 506 in the bundle configuration 508, such that the signal fiber 102 and the set of one or more pump fibers 506 are packed closely together (e.g., such that sizes of gaps between the signal fiber 102 and the set of one or more pump fibers 506 are minimized). For example, within a cross-section of the bundle configuration 508, the signal fiber 102 may be disposed in an inner area (e.g., of the cross-section of the bundle configuration 508) and the set of one or more pump fibers 506 may be disposed in association with a perimeter region (e.g., of the cross-section of the bundle configuration 508) such that the set of one or more pump fibers 506 touch and circumferentially surround the signal fiber 102.

As shown in FIG. 5B and by reference number 510, the process may include performing a bundle unification process to cause the bundle configuration 508 to form a unified bundle configuration. For example, the bundle unification process may include applying heat and a tensile force to a portion 512 of the bundle configuration 508. For example, the system may hold the bundle configuration 508 at a first end of the portion 512 and/or a second end of the portion 512, and may cause the first end and the second end to move away from each other (e.g., move outwardly, along a longitudinal axis of the bundle configuration 508). This may cause a tensile force to be applied to the portion 512 of the bundle configuration 508. At a same time (e.g., while the tensile force is applied to the portion 512 of the bundle configuration 508), heat may be applied (e.g., using a scanning flame, or another heat source) to apply heat to the portion 512 of the bundle configuration 508. As a result of the applied heat, the signal fiber 102 and the set of one or more pump fibers 506 may soften (e.g., along the portion 512 of the bundle configuration 508), and, as a result of the tensile force, the signal fiber 102 and the set of one or more pump fibers 506 may fuse together (e.g., partially fuse or completely fuse together along the portion 512 of the bundle configuration 508), such as shown in FIG. 3B. Further, the fiber core 104 of the signal fiber 102 may be caused to have a uniform thickness profile (e.g., along the portion 512 of the bundle configuration 508). That is, the signal fiber 102 may no longer be a pre-processed signal fiber or an uptapered signal fiber.

Because a fiber cladding 106 of the signal fiber 102, prior to performance of the bundle unification process, may have had more than one thickness profile along the signal fiber 102, a different amount of heat and/or tensile force may need to be used to fuse together the signal fiber 102 and the set of one or more pump fibers 506. This may result in an improved fusion of the signal fiber 102 and the set of one or more pump fibers 506, and/or may conserve resources (e.g., heating resources and/or force application resources) that would otherwise be utilized to perform a bundle unification process with a signal fiber 102 that has a fiber cladding 106 with only a single thickness profile along the signal fiber 102 (e.g., as described herein in relation to FIG. 4B and reference number 410).

As shown in FIG. 5C, by reference number 514, the process may include performing an attachment process to cause an end of the bundle configuration 508 (e.g., hereinafter referred to as the unified bundle configuration 508) to attach to an end of an output fiber 516 (e.g., that includes a fiber core 518, a fiber cladding 520, and/or a fiber coating 522). For example, the attachment process may include the system splicing the end of the unified bundle configuration 508 to the end of the output fiber 516 (e.g., at a splice point 524). This may cause an end of the fiber core 104 of the signal fiber 102 at the end of the unified bundle configuration 508 to attach to an end of the fiber core 518 of the output fiber 516. In some implementations, a thickness of the end of the fiber core 104 of the signal fiber 102 at the end of the unified bundle configuration 508 may match a thickness of the end of the fiber core 518 of the output fiber 516. For example, a difference between the thickness of the end of the fiber core 104 of the signal fiber 102 and the thickness of the end of the fiber core 518 of the output fiber 516 may be less than or equal to a thickness difference threshold, which may be less than or equal to 10 μm, 15 μm, and/or 25 μm, among other examples.

In this way, the system may form the pump-signal combiner 502 to include the signal fiber 102 and the set of one or more pump fibers 506 in the unified bundle configuration 508 that are attached to the output fiber 516. Accordingly, pump light propagated by the set of one or more pump fibers 506 may combine with a signal beam propagated by the signal fiber 102 within the unified bundle configuration 508. This may increase a power (e.g., an optical power) and/or a brightness of the signal beam. The signal beam (e.g., after combining with the pump light) may then propagate to the output fiber 516 and emit from the pump-signal combiner 502. Because the thickness of the end of the fiber core 104 of the signal fiber 102 at the end of the unified bundle configuration 508 may match the thickness of the end of the fiber core 518, the power and/or the brightness of the signal beam may be preserved (or power loss and/or brightness degradation may be minimized) as the signal beam propagates to the output fiber 516.

FIGS. 5A-5C are provided as an example. Other examples may differ from what is described with regard to FIGS. 5A-5C.

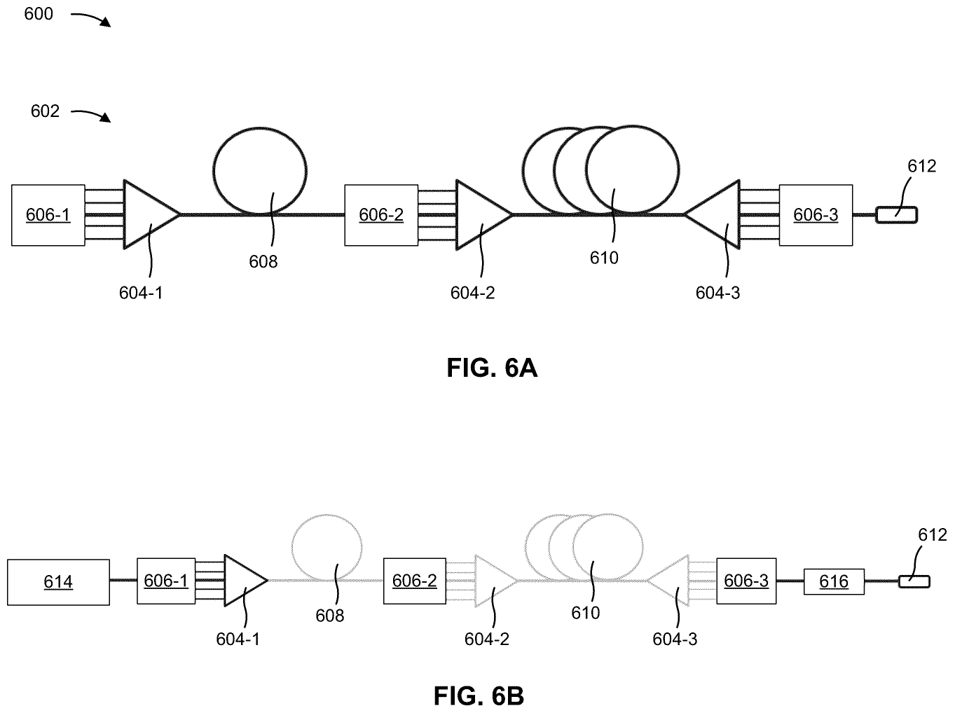

FIGS. 6A-6B are diagrams of example implementations 600 described herein. As shown in FIGS. 6A-6B, each example implementation 600 may include an optical system 602 that include multiple pump-signal combiners 604 (e.g., one or more of the pump-signal combiners 402 and/or 502 described herein in relation to FIGS. 4A-4C and 5A-5C), multiple sets of laser sources 606, an oscillator 608, one or more amplifiers 610, and/or a laser output 612.

As shown in FIG. 6A, a first set of laser sources 606-1 may be configured to provide a first signal beam and first pump light to a first pump-signal combiner 604-1 (e.g., that is configured as an end pump), which may combine the first signal beam and the first pump light to form a first combined signal beam (e.g., in a similar manner as described elsewhere herein). The first pump-signal combiner 604-1 may provide the first combined signal beam to the oscillator 608, which may provide the first combined signal beam to a second pump-signal combiner 604-2 (e.g., that is configured as a cascade pump). A second set of laser sources 606-2 may be configured to provide second pump light to the second pump-signal combiner 604-2, which may combine the first combined signal beam and the second pump light to form a second combined signal beam. The second pump-signal combiner 604-2 may provide the second combined signal beam to the one or more amplifiers 610, which may amplify and provide the second combined signal beam to a third pump-signal combiner 604-3 (e.g., that is configured as a counter pump). A third set of laser sources 606-3 may be configured to provide third pump light (e.g., that propagates in an opposite direction of a propagation direction of the second combined signal beam) to the third pump-signal combiner 604-3, which may combine the second combined signal beam and the third pump light to form and provide a third combined signal beam to the laser output 612 (e.g., that may emit the third combined signal beam at a target of the optical system 602).

As shown in FIG. 6B, the optical system 602 may additionally include a visible aiming laser source 614 and a cladding light stripper 616. Accordingly, the visible aiming laser source 614 may provide visible aiming light to the first pump-signal combiner 604-1 (e.g., to a fiber core 104 of the first pump-signal combiner 604-1), which may therefore combine the first pump light, and the visible aiming light to form the first combined signal beam. The visible aiming light may thereby propagate through the optical system 602 to the laser output 612 (e.g., that may emit the visible aiming light at the target of the optical system 602), as described above. The cladding light stripper 616 may not remove the visible aiming light because the visible aiming light propagates via a fiber core (e.g. a fiber core 104) from the first pump-signal combiner 604-1 to the laser output 612.

FIGS. 6A-6B are provided as an example. Other examples may differ from what is described with regard to FIGS. 6A-6B.

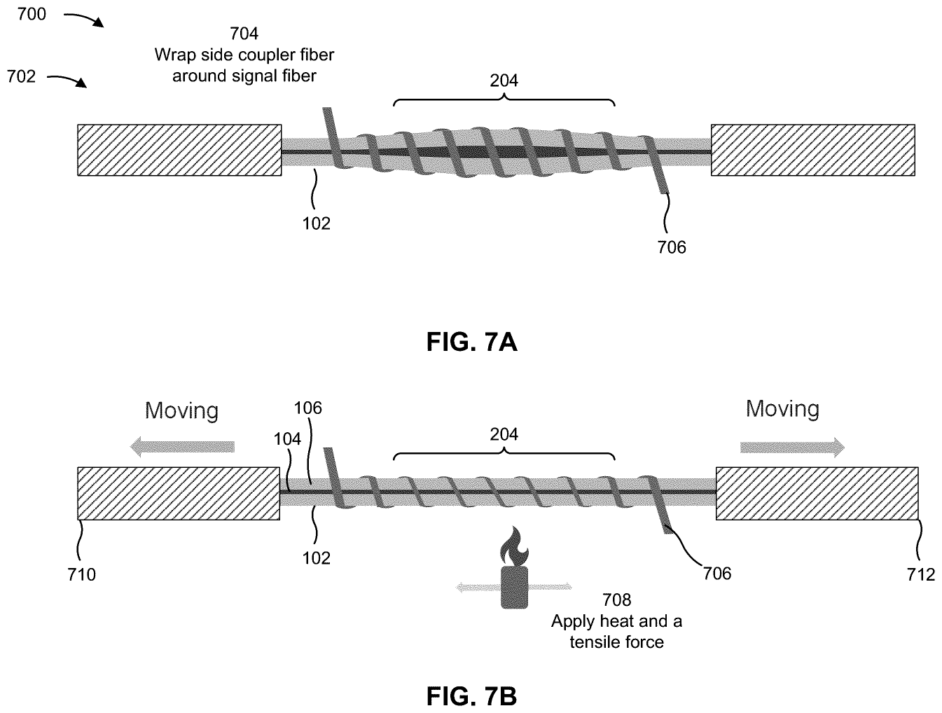

FIGS. 7A-7B are diagrams of an example implementation 700 of a process for forming a side coupler 702 described herein. As shown in FIGS. 7A-7B (e.g., that show a longitudinal cross-section of the side coupler 702), the process may include one or more steps.

As shown in FIG. 7A, and by reference number 704, the process may include wrapping a side coupler fiber 706 around a signal fiber 102. For example, a system (e.g., that is configured to form a side coupler) may wrap the side coupler fiber 706 around the signal fiber 102 in a helical configuration.

The side coupler fiber 706 may be similar to a pump fiber 406 or 506 described herein (e.g., in relation to FIGS. 4A-4C and 5A-5C). The signal fiber 102 may be a pre-processed signal fiber or an uptapered signal fiber, that may have been formed using a pre-processing or uptapering process (e.g., as described herein in relation to FIGS. 2A-2E and 3A-3E). In some implementations, the signal fiber 102 may be formed to have the portion 204 (e.g., that includes the first sub-portion 210-1 and the second sub-portion 210-2), as described herein in relation to FIG. 2B.

As shown in FIG. 7B, and by reference number 708, the process may include applying heat and a tensile force to the portion 204 of the signal fiber 102. For example, the system may hold the signal fiber 102 at a first end 710 (the left end of the signal fiber 102 shown in FIG. 7B) and/or a second end 712 (the right end of the signal fiber 102 shown in FIG. 7B), and may cause the first end 710 and the second end 712 to move away from each other (e.g., move outwardly, along a longitudinal axis of the signal fiber 102). This may cause a tensile force to be applied to the portion 204 of the signal fiber 102. At a same time (e.g., while the tensile force is applied to the portion 204 of the signal fiber 102), heat may be applied (e.g., using a scanning flame, or another heat source) to apply heat to the portion 204 of the signal fiber 102. As a result of the applied heat, the fiber core 104 and the fiber cladding 106 of the portion 204 of the signal fiber 102 may soften and, as a result of the tensile force, respective thicknesses of the fiber core 104 and the fiber cladding 106 of the portion 204 of the signal fiber 102 may decrease, such as shown in FIG. 7B.

In this way, the side coupler 702 may be formed to cause the fiber core 104 and the fiber cladding 106 of the signal fiber 102 to each have a uniform thickness profile along the portion 204 of the signal fiber 102 (and one or more other portions of the signal fiber 102). This increases a side coupling efficiency of the side coupler 702 (e.g., increases evanescent wave coupling between the side coupler fiber 706 and the signal fiber 102).

FIGS. 7A-7B are provided as an example. Other examples may differ from what is described with regard to FIGS. 7A-7B.

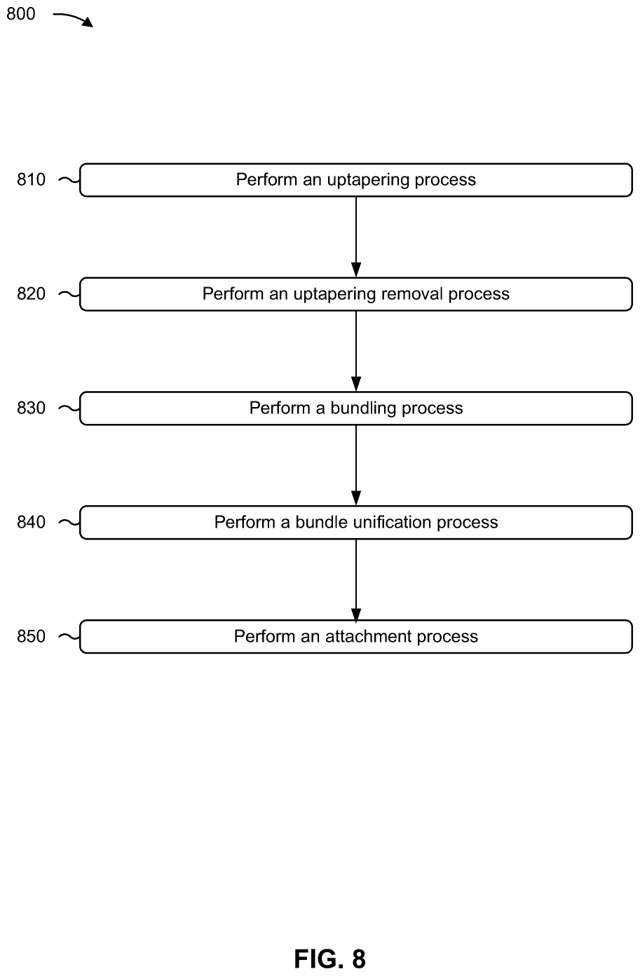

FIG. 8 is a flowchart of an example process 800 associated with forming a pump-signal combiner. In some implementations, one or more process blocks of FIG. 8 are performed by a system (e.g., that is configured to form a pump-signal combiner). In some implementations, one or more process blocks of FIG. 8 are performed by another device or a group of devices separate from or including the system, such as another system (e.g., that is configured to form a pre-processed signal fiber or an uptapered signal fiber).

As shown in FIG. 8, process 800 may include performing an uptapering process (block 810). For example, the system may perform an uptapering process to cause a signal fiber to have a fiber core with a first uptapered thickness profile and a fiber cladding with a second uptapered thickness profile, as described above.

As further shown in FIG. 8, process 800 may include performing an uptapering removal process (block 820). For example, the system may perform, after performing the uptapering process, an uptapering removal process to cause the fiber cladding of the signal fiber to not have the second uptapered thickness profile, as described above.

As further shown in FIG. 8, process 800 may include performing a bundling process (block 830). For example, the system may perform, after performing the uptapering removal process, a bundling process to bundle the signal fiber and a set of one or more pump fibers in a bundle configuration, as described above.

As further shown in FIG. 8, process 800 may include performing a bundle unification process (block 840). For example, the system may perform, after performing the bundling process, a bundle unification process to cause the bundle configuration to form a unified bundle configuration, as described above.

As further shown in FIG. 8, process 800 may include performing an attachment process (block 850). For example, the system may perform, after performing the bundle unification process, an attachment process to cause an end of the unified bundle configuration to attach to an end of an output fiber, as described above.

Process 800 may include additional implementations, such as any single implementation or any combination of implementations described below and/or in connection with one or more other processes described elsewhere herein.

In a first implementation, performing the uptapering process comprises applying heat and a compressive force to a portion of the signal fiber, and cleaving the portion of the signal fiber.

In a second implementation, alone or in combination with the first implementation, performing the uptapering process comprises applying heat and a tensile force to a portion of another signal fiber, cleaving the portion of the other signal fiber, and splicing the other signal fiber to the signal fiber.

In a third implementation, alone or in combination with one or more of the first and second implementations, splicing the other signal fiber to the signal fiber comprises splicing an end of the other signal fiber associated with the portion of the other signal fiber to an end of the signal fiber, wherein a thickness of the fiber core of the signal fiber at the end of the signal fiber matches a thickness of a fiber core of the other signal fiber at the end of the other signal fiber.

In a fourth implementation, alone or in combination with one or more of the first through third implementations, the uptapering removal process includes performing at least one of an etching process, a lasering process, or a machining process.

In a fifth implementation, alone or in combination with one or more of the first through fourth implementations, performing the uptapering removal process causes the fiber cladding to have a uniform thickness profile along a length of the signal fiber, or a stepped thickness profile along the length of the signal fiber.

In a sixth implementation, alone or in combination with one or more of the first through fifth implementations, performing the bundle unification process comprises applying heat and a tensile force to a portion of the bundle configuration to cause the signal fiber and the set of one or more pump fibers to fuse together along the portion of the bundle configuration, and the fiber core of the signal fiber to have, along the portion of the bundle configuration, a uniform thickness profile.

In a seventh implementation, alone or in combination with one or more of the first through sixth implementations, performing the attachment process comprises splicing the end of the unified bundle configuration to the end of the output fiber to cause an end of the fiber core of the signal fiber at the end of the unified bundle configuration to attach to an end of a fiber core of the output fiber, wherein a thickness of the end of the fiber core of the signal fiber at the end of the unified bundle configuration matches a thickness of the end of the fiber core of the output fiber.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” “left,” “right,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A method of forming a pump-signal combiner, comprising:
performing, by a system, an uptapering process to cause a signal fiber to have a fiber core with a first uptapered thickness profile and a fiber cladding with a second uptapered thickness profile;
performing, by the system and after performing the uptapering process, an uptapering removal process to cause the fiber cladding of the signal fiber to not have the second uptapered thickness profile;
performing, by the system and after performing the uptapering removal process, a bundling process to bundle the signal fiber and a set of one or more pump fibers in a bundle configuration;
performing, by the system and after performing the bundling process, a bundle unification process to cause the bundle configuration to form a unified bundle configuration; and
performing, by the system and after performing the bundle unification process, an attachment process to cause an end of the unified bundle configuration to attach to an end of an output fiber.

2. The method of claim 1, wherein performing the uptapering process comprises:
applying heat and a compressive force to a portion of the signal fiber; and
cleaving the portion of the signal fiber.

3. The method of claim 1, wherein performing the uptapering process comprises:
applying heat and a tensile force to a portion of another signal fiber;
cleaving the portion of the other signal fiber; and
splicing the other signal fiber to the signal fiber.

4. The method of claim 3, wherein splicing the other signal fiber to the signal fiber comprises:
splicing an end of the other signal fiber associated with the portion of the other signal fiber to an end of the signal fiber,
wherein a thickness of the fiber core of the signal fiber at the end of the signal fiber matches a thickness of a fiber core of the other signal fiber at the end of the other signal fiber.

5. The method of claim 1, wherein the uptapering removal process includes performing at least one of:
an etching process,
a lasering process, or
a machining process.

6. The method of claim 1, wherein performing the uptapering removal process causes the fiber cladding to have:
a uniform thickness profile along a length of the signal fiber, or
a stepped thickness profile along the length of the signal fiber.

7. The method of claim 1, wherein performing the bundle unification process comprises:
applying heat and a tensile force to a portion of the bundle configuration to cause:
the signal fiber and the set of one or more pump fibers to fuse together along the portion of the bundle configuration; and
the fiber core of the signal fiber to have, along the portion of the bundle configuration, a uniform thickness profile.

8. The method of claim 1, wherein performing the attachment process comprises:
splicing the end of the unified bundle configuration to the end of the output fiber to cause:
an end of the fiber core of the signal fiber at the end of the unified bundle configuration to attach to an end of a fiber core of the output fiber,
wherein a thickness of the end of the fiber core of the signal fiber at the end of the unified bundle configuration matches a thickness of the end of the fiber core of the output fiber.

9. A method of forming a pump-signal combiner, comprising:
performing, by a system, an uptapering process to cause a signal fiber to have a fiber core with a first uptapered thickness profile;
performing, by the system and after performing the uptapering process, a bundling process to bundle the signal fiber and a set of one or more pump fibers in a bundle configuration; and
performing, by the system and after performing the bundling process, an attachment process to cause an end of the bundle configuration to attach to an end of an output fiber.

10. The method of claim 9, wherein performing the uptapering process comprises:
applying heat and a compressive force to a portion of the signal fiber; and
cleaving the portion of the signal fiber.

11. The method of claim 9, wherein performing the uptapering process comprises:
applying heat and a tensile force to a portion of another signal fiber;
cleaving the portion of the other signal fiber; and
splicing the other signal fiber to the signal fiber.

12. The method of claim 9, further comprising:
performing, after performing the uptapering process and before performing the bundling process, an uptapering removal process to cause a fiber cladding of the signal fiber to not have a second uptapered thickness profile.

13. The method of claim 9, further comprising:
performing, after performing the bundling process and before performing the attachment process, a bundle unification process to cause the bundle configuration to form a unified bundle configuration.

14. The method of claim 13, wherein performing the bundle unification process comprises:
applying heat and a tensile force to a portion of the bundle configuration to cause:
the fiber core of the signal fiber to have, along the portion of the bundle configuration, a uniform thickness profile.

15. The method of claim 9, wherein performing the attachment process comprises:
causing an end of the fiber core of the signal fiber at the end of the bundle configuration to attach to an end of a fiber core of the output fiber,
wherein a thickness of the end of the fiber core of the signal fiber at the end of the bundle configuration matches a thickness of the end of the fiber core of the output fiber.

16. A method of forming a pump-signal combiner, comprising:
performing, by a system, an uptapering process to cause a signal fiber to have a fiber core with a first uptapered thickness profile;
performing, by the system and after performing the uptapering process, a bundling process to bundle the signal fiber and a set of one or more pump fibers in a bundle configuration; and
performing, by the system and after performing the bundling process, a bundle unification process to cause the bundle configuration to form a unified bundle configuration.

17. The method of claim 16, wherein performing the uptapering process comprises:
applying heat and a compressive force to a portion of the signal fiber.

18. The method of claim 16, wherein performing the uptapering process comprises:
applying heat and a tensile force to a portion of another signal fiber; and
attaching the other signal fiber to the signal fiber.

19. The method of claim 16, wherein performing the bundle unification process comprises:
applying heat and a tensile force to a portion of the bundle configuration to cause:
the fiber core of the signal fiber to have, along the portion of the bundle configuration, a uniform thickness profile.

20. The method of claim 16, wherein performing the uptapering process is to further cause the signal fiber to have a fiber cladding with a second uptapered thickness profile, and
wherein the method further comprises performing, after performing the uptapering process and before performing the bundling process, an uptapering removal process to cause the fiber cladding of the signal fiber to not have the second uptapered thickness profile.
